(19) United States
(12) Patent Application Publication
(10) Pub. No.: US 2005/0089252 A1
(43) Pub. Date: Apr. 28, 2005

(54) Dynamic gas bearing of a shaft comprising polygonal mirrors and a low-pressure polygonal room

(76) Inventor: Gerhard Wanger, Arberg (DE)

Correspondence Address: WILLIAM COLLARD;COLLARD & ROE, P.C., 1077 NORTHERN BOULEVARD, ROSLYN, NY, 11576, US

(21) Appl. No.: 10/498,539

(22) PCT Filed: Dec. 6, 2002
(86) PCT No.: PCT/DE02/04484

(30) Foreign Application Priority Data
Dec. 19, 2001 (DE) 10162675.4

(51) Int. Cl. F16C 32/06

(52) U.S. Cl. 384/100

(57) ABSTRACT

The invention relates to a dynamic gas bearing of a motor spindle comprising a rotating shaft that is received in a housing on gas bearings in the radial and axial direction, said shaft comprising a polygonal mirror in a polygonal room, for radially bearing along the shaft at least one radial gas bearing and for axially bearing a front and a rear gas bearing. The ratio of the bearing gap of the rear axial bearing combined with the bearing gap of the front axial bearing attains at least the value 2.

The invention relates to a dynamic gas bearing of a motor spindle having a rotating shaft having the features of the preamble of patent claim 1. The invention also relates to a method for operating a dynamic gas bearing of a motor spindle having the features of the preamble of patent claim 14.

A dynamic gas bearing on whose rotating shaft a polygon is attached in a polygonal chamber is known as prior art from the German patent application of file reference 100 55 787.2 (applicant: Gerhard Wanger). When such a dynamic gas bearing is used for laser projection, the rotating shaft is operated at very high rotational speeds (for example over 100 000 rpm), as a result of which air vortices which, on the one hand, vary the refractive index of light in the polygonal chamber and, on the other hand, impair the accuracy with which the rotating shaft is supported can occur in the polygonal chamber in the region of the polygonal mirror.

It is the object of the invention to offer a dynamic gas bearing of a motor spindle and a method for operating such a dynamic gas bearing, with in both cases a reduction in the production of air vortices in the polygonal chamber.

The object is achieved for the dynamic gas bearing by means of the features of the characterizing part of patent claim 1 in conjunction with the features of the preamble. Advantageous embodiments of the dynamic gas bearing are described in the subclaims 2-13. For the method, the object is achieved by means of the features of the characterizing part of patent claim 14 in conjunction with the features of the preamble. An advantageous variant of the method is described in patent claim 15.

For the dynamic gas bearing, the object is achieved by virtue of the fact that the ratio of the bearing gap of the rear axial bearing to the bearing gap of the front axial bearing reaches at least the value 2. As a result, the bearing gap of the rear axial bearing is at least twice as large as the bearing gap of the front axial bearing, and so the rear axial bearing essentially serves as a pump, and the front axial bearing essentially serves as a support bearing. The pump action of the rear axial bearing produces low pressure in the polygonal chamber and discharges air from the polygonal chamber. Disturbing air vortices in the polygonal chamber are thereby suppressed. It is therefore possible to achieve a higher running accuracy of the polygonal mirror, since the couple unbalance of the polygonal shaft is substantially smaller. Moreover, during operation at low pressure the pressure fluctuations of the air about the polygonal mirror are reduced, and the refractive index of light is not subjected to any irregular variations, the result being to ensure a precise deflection of the laser beam. In addition, during operation at low pressure the air friction of the polygonal mirror is reduced, something which has a positive effect through lower power losses, chiefly at high rotational speeds of the polygonal shaft.

In order to improve its supporting action, the front axial bearing is closed in the inner diameter region. In order to discharge air that is to be pumped out, the rear axial bearing can have a connection to the radial gas bearing, so as to discharge pumped-out air in the direction of the radial gas bearing.

The ratio of the axial supporting force of the front axial bearing to the supporting force of the rear axial bearing advantageously exceeds the value 3 such that the front axial bearing is used first and foremost as a “supporting bearing”, and the rear axial bearing is used first and foremost as a “pumping bearing” on the basis of the widened air gap and the lower-supporting force.

The production of low pressure for the two axial bearings is further increased when the axial stiffness of the rear axial bearing is at most 30% of the axial stiffness of the front axial bearing.

Overall, according to an advantageous embodiment the total axial bearing play, that is to say the sum of the two bearing gaps of the front and rear axial bearings can be between 4-18 μm.

According to a further advantageous embodiment, the front axial bearing is connected to an excess-pressure chamber via a pressure-equalizing bore. As a result of this, the rapidly rotating shaft of the polygon can be braked down to a standstill within a very short time, and in the process the low pressure built up in the polygonal chamber can be reduced via the pressure-equalizing bore connected to the excess-pressure chamber.

In a further advantageous embodiment, the front and rear axial bearings are designed as spiral flute bearings and advantageously have different spiral flute geometries in order—that is the aim—to design the front axial bearing as principally a “supporting bearing” and the rear axial bearing as principally a “pumping bearing”.

In the method according to the invention for avoiding air vortices, low pressure is produced in the polygonal chamber of the rotating shaft by a front and a rear axial bearing in order to operate a dynamic gas bearing. According to the invention, it is possible to build up the desired low pressure by appropriate configuration of the front and rear axial bearings without the need for a separate evacuation device.

The invention will be explained in more detail with the aid of exemplary embodiments in the figures of the drawing, in which:

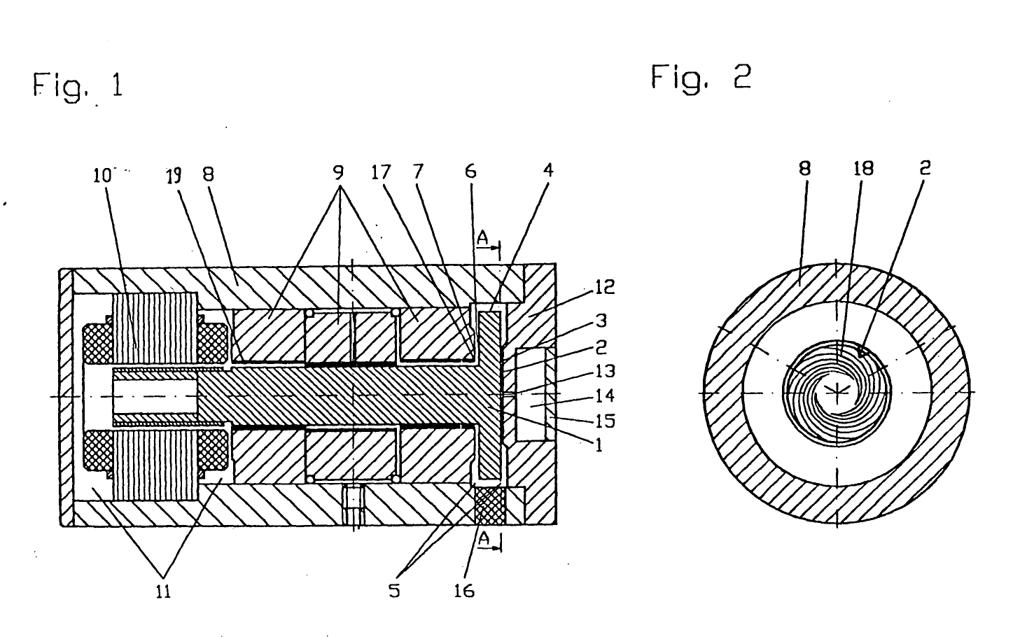

FIG. 1 shows a longitudinal section through a substantially cylindrically designed housing of the dynamic gas bearing, and

FIG. 2 shows a section A-A according to FIG. 1.

FIG. 1 shows a dynamic gas bearing having a shaft 1, driven by a drive 10 in a drive chamber 11, with a polygonal mirror 4 in the front region of the shaft 1. The shaft 1 is held via radial gas bearings 9 (known per se from German patent application of file reference 100 55 787.2, applicant: Gerhard Wanger) as well as by a front axial bearing 2 and a rear axial bearing 7 in the housing 8 of the dynamic gas bearing. The polygonal chamber 5 has a window 16 for projecting laser beams reflected at the rotating polygonal mirror 4. In the case of the dynamic gas bearing according to FIG. 1, the front axial bearing 2 chiefly has a support function and serves to stabilize the shaft 1 axially. The rear axial bearing 7 serves chiefly as a pump in order to produce low pressure in the sealed polygonal chamber 5 and to pump out air that is there in the direction of the drive chamber 11, for example by a connection 17 and an opening 19. The drive chamber 11 is, in particular, of (largely) gastight design and connected to a bearing gap of the radial gas bearing 9 and the polygonal chamber 5 only via the opening 19. The volume of the polygonal chamber 5 is advantageously to exceed the volume of the drive chamber 11 by at most 40 percent, in order to achieve adequate low pressure in the polygonal chamber 5.

The air pumped out of the polygonal chamber 5 by the rear axial bearing 7 is fed to the bearing gaps of the radial gas bearings via a connection 17.

The front axial bearing 2 and the rear axial bearing 7 are designed, in particular, as spiral flute bearings, the spiral flute geometry of the front axial bearing 2 being designed to absorb loads and to attain an increased supporting force. At the front side, the polygonal chamber 5 is sealed by the cover 12. The front axial bearing 2 is connected to an excess-pressure chamber 14 via a pressure-equalizing bore 13 in the cover 12. Said chamber can be covered by a plate 15. In the event of sudden braking of the shaft 1 from high rotational speeds (for example of over 100 000 rpm) down to a standstill, the low pressure built up in the polygonal chamber 5 by the pumping action of the rear axial bearing 7 during the rotation of the shaft 1 is decreased via the pressure-equalizing bore 13. This permits the shaft 1 to be rapidly run down and braked. The axial bearing play of the polygonal shaft 1 was set by precise coordination of dimensions at the cover 12 or at the housing 8.

FIG. 2 shows a sectional illustration of the housing 8 and of the front axial bearing 2 with a spiral flute profile 18.

### REFERENCE NUMERALS

1 Shaft
2 Front axial bearing
3 Front axial bearing gap
4 Polygonal mirror
5 Polygonal chamber
6 Rear axial bearing gap
7 Rear axial bearing
8 Housing
9 Radial gas bearing
10 Drive
11 Drive chamber
12 Cover
13 Pressure-equalizing bore
14 Excess-pressure chamber
15 Plate
16 Window
17 Connection
18 Spiral flute profile
19 Opening

1. A dynamic gas bearing of a motor spindle having a rotating shaft that is supported on gas bearings in the radial and axial directions in a housing, the shaft having a polygonal mirror in a polygonal chamber, and there being provided at least one radial gas bearing for the radial support along the shaft and a front and a rear gas bearing for axial support, wherein the ratio of the bearing gap (6) of the rear axial bearing (7) to the bearing gap (3) of the front axial bearing (2) reaches at least the value 2.

2. The dynamic gas bearing as claimed in claim 1, wherein the front axial bearing (2) is closed in an inner diameter region.

3. The dynamic gas bearing as claimed in claim 1, wherein the rear axial bearing (7) has a connection (17) to the radial gas bearing (9).

4. The dynamic gas bearing as claimed in claim 1, wherein the bearing gap (3) of the front axial bearing (2) occupies at most 33% of the total axial bearing play of the polygonal shaft (1).

5. The dynamic gas bearing as claimed in claim 1, wherein the ratio of the axial supporting force of the front axial bearing (2) to the supporting force of the rear axial bearing (7) exceeds the value 3.

6. The dynamic gas bearing as claimed in claim 1, wherein the axial stiffness of the rear axial bearing (7) is at most 30% of the axial stiffness of the front axial bearing (2).

7. The dynamic gas bearing as claimed in claim 1, wherein the total axial bearing play of the shaft (1) is between 4-18 μm.

8. The dynamic gas bearing as claimed in claim 1, wherein the front axial bearing (2) is connected to an excess-pressure chamber (14) via a pressure-equalizing bore (13).

9. The dynamic gas bearing as claimed in claim 1, wherein the front axial bearing (2) and the rear axial bearing (7) are designed as a spiral flute bearing.

10. The dynamic gas bearing as claimed in claim 9, wherein the front and the rear axial bearings (2, 7) have different spiral flute geometries.

11. The dynamic gas bearing as claimed in claim 1, wherein a drive chamber (11) is provided for holding the drive (10) of the gas bearing.

12. The dynamic gas bearing as claimed in claim 11, wherein the drive chamber (11) is embodied in a gastight fashion up to an opening (19) to the bearing gap of the radial gas bearing (9).

13. The dynamic gas bearing as claimed in claim 11, wherein the volume of the polygonal chamber (5) is at most 40 percent larger than the volume of the drive chamber (11).

14. A method for operating a dynamic gas bearing of a motor spindle having a rotating shaft having a polygonal mirror in a polygonal chamber, in particular a dynamic gas bearing as claimed in claim 1, wherein low pressure is produced by a front axial bearing (2) and a rear axial bearing (7) in order to reduce air vortices.

15. The method as claimed in claim 14, wherein the front axial bearing (2) essentially has a support function for absorbing axial bearing forces, and the rear axial bearing (7) essentially has a pumping function for pumping air out of the polygonal chamber.
